(19) United States
(12) Patent Application Publication
(10) Pub. No.: US 2024/0063497 A1
(43) Pub. Date: Feb. 22, 2024

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nobuyuki MATSUMURA, Osaka (JP); Shinichi TAKASE, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/270,582

(22) PCT Filed: Jan. 6, 2022
(86) PCT No.: PCT/JP2022/000173

§ 371 Date: Jun. 30, 2023

(30) Foreign Application Priority Data
Jan. 19, 2021 (JP) 2021-006350

(51) Int. Cl. H01M 50/298; H01M 50/209; H01M 50/507; H01M 50/503; H01M 50/271; H01M 50/284; B60R 16/02

(52) U.S. Cl. CPC H01M 50/298; H01M 50/209; H01M 50/507; H01M 50/503; H01M 50/271; H01M 50/284; B60R 16/0215; H01M 2220/20; B60L 50/64

(57) ABSTRACT

A wiring module is a wiring module that is mounted on a plurality of power storage elements. The wiring module includes busbars that are connected to electrode terminals of the plurality of power storage elements, flexible substrates that are connected to busbar-side connection parts provided at the busbars, a circuit substrate that is connected to the flexible substrates, and a protector on which the busbars, the flexible substrates, and the circuit substrate are placed. An upper surface of the circuit substrate is disposed above upper surfaces of the busbar-side connection parts.

### TECHNICAL FIELD

The present disclosure relates to a wiring module.

### BACKGROUND ART

High-voltage battery packs used in electric automobiles, hybrid automobiles, and the like include a plurality of battery aggregates in which a large number of battery cells are stacked, and that are electrically connected in series or in parallel by busbar modules. As a battery state detection device for such a battery pack, the device disclosed in JP 2018-054334A (hereinafter Patent Document 1) is conventionally known. The battery state detection device disclosed in Patent Document 1 is integrated with a busbar module and includes a main unit and a sub-unit for detecting the states of the battery aggregates. The main unit and the sub-unit are formed by rigid substrates and are connected to the battery cells via voltage detection lines formed by flexible printed substrates or the like.

### CITATION LIST

### Patent Document

Patent Document 1: JP 2018-054334A

### SUMMARY OF INVENTION

### Technical Problem

The battery pack is generally configured by housing battery aggregates such as those above in a casing, and is installed in a vehicle or the like. The battery aggregates generate heat as the vehicle or the like is used. Thus, water dew is likely to form on the battery aggregates in the casing due to a temperature difference between the inside and the outside of the casing. The water dew may cause dust contamination or the like. Condensation and contamination in the battery pack may cause serious problems such as a short circuit in the main unit and the sub-unit where many electronic components are mounted.

### Solution to Problem

A wiring module of the present disclosure is a wiring module that is mounted on the upper side of a plurality of power storage elements. The wiring module includes a busbar that is connected to electrode terminals of the plurality of power storage elements, a flexible substrate that is connected to a busbar-side connection part provided on the busbar, a circuit substrate that is connected to the flexible substrate, and a protector on which the busbar, the flexible substrate, and the circuit substrate are placed. The upper surface of the circuit substrate is disposed above the upper surface of the busbar-side connection part.

### Advantageous Effects of Invention

According to the present disclosure, it is possible to provide a wiring module that is capable of suppressing a short circuit caused by condensation and contamination on a circuit substrate.

### BRIEF DESCRIPTION OF DRAWINGS

FIG. 1 is a schematic view of a vehicle in which a power storage module according to a first embodiment is mounted.

FIG. 2 is a perspective view of the power storage module.

FIG. 3 is a plan view of the power storage module.

FIG. 4 is a plan view of the power storage module from which an outer cover is removed from the state in FIG. 3.

FIG. 5 is a plan view of the power storage module from which a cover is removed from the state in FIG. 4.

FIG. 6 is an enlarged view of FIG. 5 that shows connection between flexible substrates and busbars and connection between the flexible substrates and a circuit substrate.

FIG. 7 is an enlarged view of FIG. 5 that shows the surrounding region of a recessed part.

FIG. 8 is a cross-sectional view of the power storage module taken along line A-A in FIG. 7.

FIG. 9 is a cross-sectional view of the power storage module taken along line B-B in FIG. 7.

FIG. 10 is a cross-sectional view of the power storage module taken along line C-C in FIG. 7.

FIG. 11 is an enlarged view of FIG. 4 that shows the surrounding region of the recessed part of the protector.

FIG. 12 is a perspective view of a cover.

FIG. 13 is a perspective view of a busbar.

FIG. 14 is a cross-sectional view of a power storage module that shows a water blocking wall according to a second embodiment.

FIG. 15 is a cross-sectional view of a power storage module that shows a closure part according to a third embodiment.

### EMBODIMENTS OF THE INVENTION

### Description of Embodiments of Present Disclosure

First, embodiments of the present disclosure will be listed and described.

(1) A wiring module of the present disclosure is a wiring module that is mounted on the upper side of a plurality of power storage elements. The wiring module includes a busbar that is connected to electrode terminals of the plurality of power storage elements, a flexible substrate that is connected to a busbar-side connection part provided on the busbar, a circuit substrate that is connected to the flexible substrate, and a protector on which the busbar, the flexible substrate, and the circuit substrate are placed. The upper surface of the circuit substrate is disposed above the upper surface of the busbar-side connection part.

According to this configuration, the circuit substrate is connected to the busbar-side connection part via the flexible substrate, and the upper surface of the circuit substrate is disposed above the upper surface of the busbar-side connection part. This suppresses the entry of water dew from the busbar into the circuit substrate.

(2) The flexible substrate preferably includes a wiring part, a first connection piece that is overlaid on and connected to the upper surface of the busbar-side connection part, and a bridge part that couples the wiring part and the first connection piece. The protector preferably has a wiring surface on which the wiring part is placed, a busbar installation part at which the busbar is disposed, and an opening that is provided between the wiring surface and the busbar installation part and extends through the protector in an up-down direction. At least a portion of the bridge part is preferably disposed above or inside the opening.

According to this configuration, water dew accumulated on the bridge part is likely to be drained downward through the opening. Accordingly, it is possible to suppress the entry of water dew from the busbar into the wiring part of the flexible substrate via the bridge part.

(3) The wiring surface is preferably disposed above the upper surface of the busbar-side connection part.

According to this configuration, since the wiring part of the flexible substrate is disposed above the first connection piece, it is possible to suppress the entry of water dew from the busbar into the wiring part via the bridge part.

(4) The bridge part preferably has a cutout part and is provided in an extendable manner.

According to this configuration, the provision of the cutout part makes the water dew likely to be drained downward from the bridge part through the opening. Even if the wiring surface and the upper surface of the busbar-side connection part are positionally shifted from each other in the up-down direction, the bridge part is vertically extendable and thus the bridge part does not need an extra length.

(5) The protector preferably has an attachment part to which the circuit substrate is attached. The attachment part preferably has a partition wall that surrounds an outer edge part of the circuit substrate and a recessed part that is provided in the partition wall. The flexible substrate preferably includes a second connection piece that extends from the wiring part and toward the circuit substrate through the recessed part. The second connection piece is preferably overlaid on and connected to the upper surface of the circuit substrate.

According to this configuration, the circuit substrate is surrounded by the partition wall except for the recessed part necessary for connecting the flexible substrate and the circuit substrate. This makes it possible to suppress the entry of water dew from outside of the attachment part into the circuit substrate.

(6) The recessed part is preferably provided with a water blocking wall that extends upward from the wiring surface and is in contact with the lower surface of the second connection piece.

According to this configuration, the water blocking wall suppresses the entry of water dew from the wiring surface and the wiring part into the circuit substrate.

(7) A cover is preferably attached to the attachment part to cover the circuit substrate from above.

According to this configuration, it is possible to suppress the entry of water dew falling from above into the circuit substrate.

(8) The cover is preferably provided with a closure part that is disposed to close the recessed part and is made of an elastic material, and a lower end portion of the closure part is preferably in contact with the upper surface of the second connection piece.

According to this configuration, the closure part can suppress the entry of water from the wiring part into the circuit substrate.

(9) The cover preferably has a cover main body part that is disposed above the attachment part and an overhang part that protrudes from the cover main body part toward the outside of the attachment part. The overhang part preferably covers the second connection piece from above. The upper surface of the overhang part is preferably inclined so as to decrease in height while extending outward from the cover main body part.

According to this configuration, it is possible to suppress the adhesion of water dew falling from above to the second connection piece. It is also possible to drain the water dew falling from above downward via the overhang part.

(10) The circuit substrate preferably includes a circuit substrate-side connection part that is connected to the second connection piece. The lower surface of the second connection piece and the upper surface of the circuit substrate-side connection part are preferably flush with each other.

According to this configuration, it is possible to improve the reliability of connection between the flexible substrate and the circuit substrate.

(11) The wiring module described above is a vehicle wiring module that is used mounted in a vehicle.

### DETAILS OF EMBODIMENTS OF PRESENT DISCLOSURE

Hereinafter, embodiments of the present disclosure will be described. It should be noted that the present disclosure is not limited to the examples herein, but rather is indicated by the claims, and is intended to include all modifications within a meaning and scope equivalent to the claims.

### First Embodiment

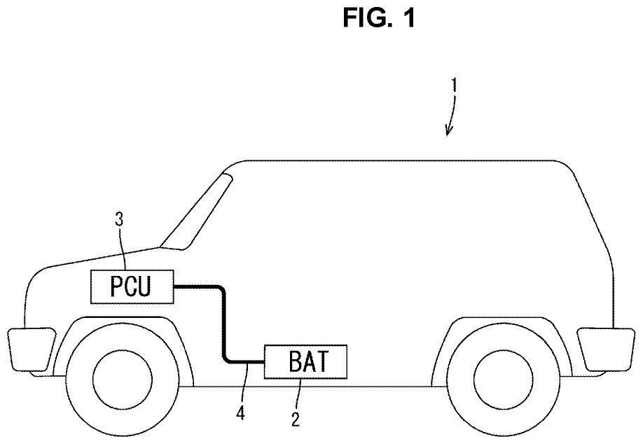

The first embodiment of the present disclosure will be described with reference to FIGS. 1 to 13. A power storage module 10 including a wiring module 20 of the present embodiment is applied to a power storage pack 2 mounted in a vehicle 1 as shown in FIG. 1, for example. The power storage pack 2 is mounted in the vehicle 1, which is as an electric automobile, a hybrid automobile, or the like, and is used as a drive source of the vehicle 1. In the following description, for a plurality of identical members, only some of the members may be denoted with reference signs and the reference signs may be omitted from the other members.

As shown in FIG. 1, the power storage pack 2 is disposed near the center of the vehicle 1. A power control unit (PCU) 3 is disposed in the front part of the vehicle 1. The power storage pack 2 and the PCU 3 are connected to each other by a wire harness 4. The power storage pack 2 and the wire harness 4 are connected via a connector (not shown). The power storage pack 2 has the power storage module 10 including a plurality of power storage elements 11. In the following description, except for FIG. 1, the direction indicated by the Z arrow will be defined as the upward direction, the direction indicated by the X arrow will be defined as the forward direction, and the direction indicated by the Y arrow will be defined as the leftward direction.

### [Water Dew in Power Storage Pack]

The power storage pack 2 includes a plurality of power storage modules 10 and a casing (not shown) that houses the plurality of power storage modules 10. Since the temperatures of the power storage elements 11, later-described busbars 40, and the like sharply change according to use of the vehicle 1, a temperature difference occurs between the inside and outside of the power storage pack 2. Due to this temperature difference, water dew is likely to form inside the casing. Hereinafter, a description will be given in particular as to a technique for suppressing water dew from adhering to the busbars 40 and the water dew adhering to the ceiling surface of the casing from entering a circuit substrate 30.

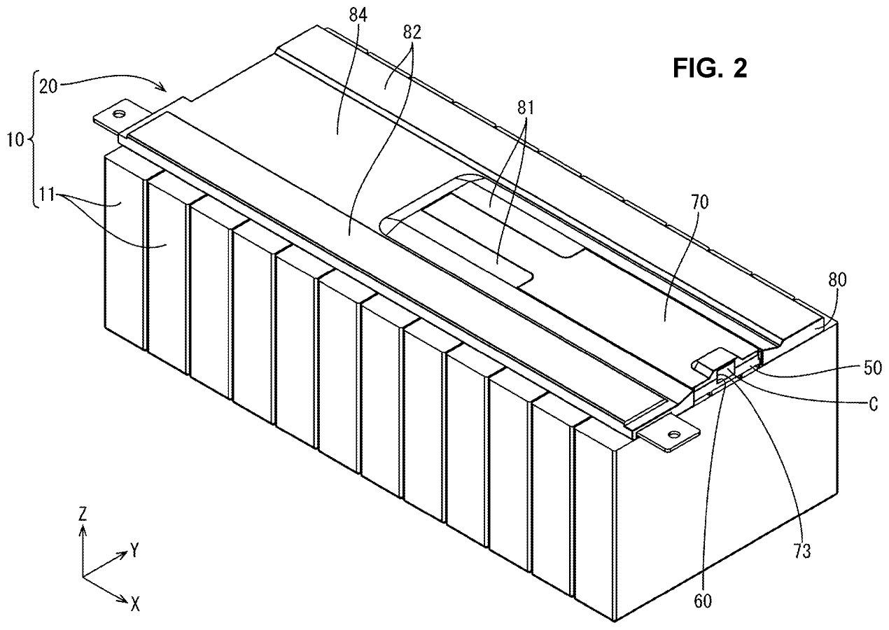

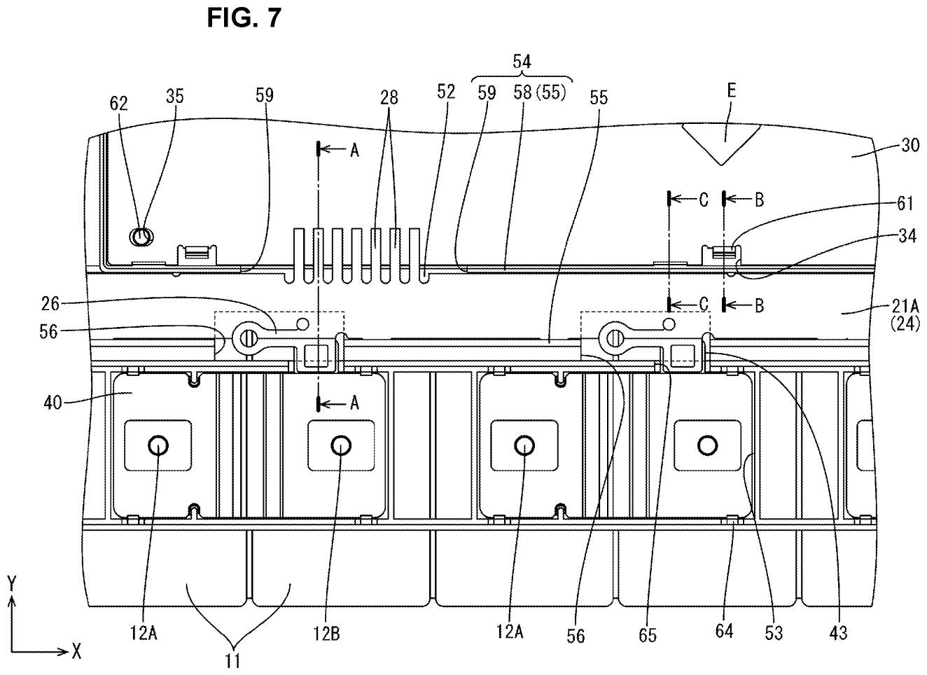

As shown in FIG. 2, each power storage module 10 includes a plurality of power storage elements 11 arranged in a line and the wiring module 20 attached to the upper surfaces of the plurality of power storage elements 11. Each power storage element 11 has a flat rectangular parallelepiped shape in which a power storing element (not shown) is contained. As shown in FIG. 7, the upper surface of each power storage element 11 has positive and negative electrode terminals 12A and 12B.

### [Wiring Module]

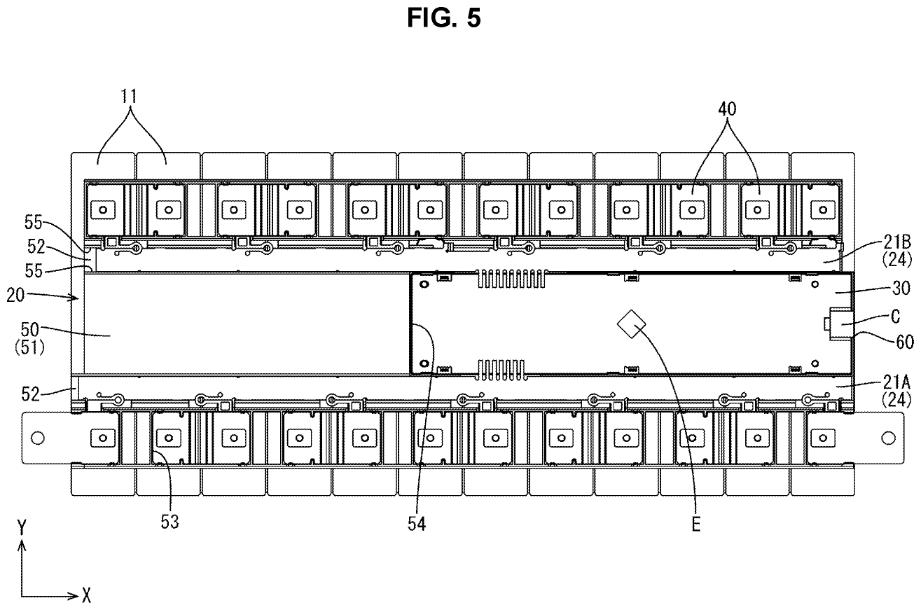

As shown in FIG. 5, the wiring module 20 includes two flexible substrates 21A and 21B, the circuit substrate 30 connected to the flexible substrates 21A and 21B, busbars 40 connected to the power storage elements 11, and a protector 50 that holds the flexible substrates 21A and 21B and the busbars 40. Since the two flexible substrates 21A and 21B have the same structure, one flexible substrate 21A and a configuration related to electrical connection of the flexible substrate 21A will be described below in detail, and description of the other flexible substrate 21B may be omitted.

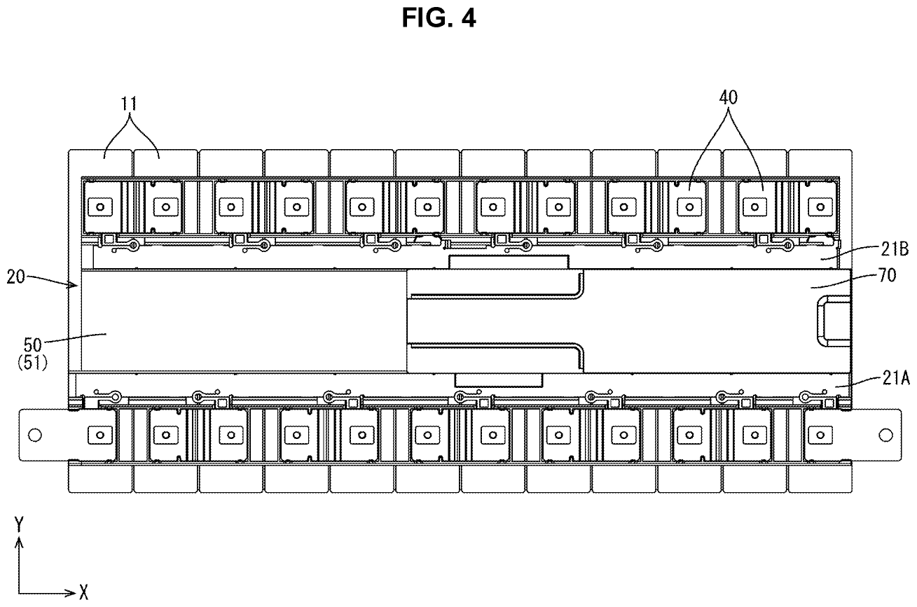

The wiring module 20 further includes a cover 70 that covers the circuit substrate 30 from above (see FIGS. 4 and 5), and an outer cover 80 that covers a region outside of the cover 70 from above (see FIGS. 2 to 4).

### [Flexible Substrate]

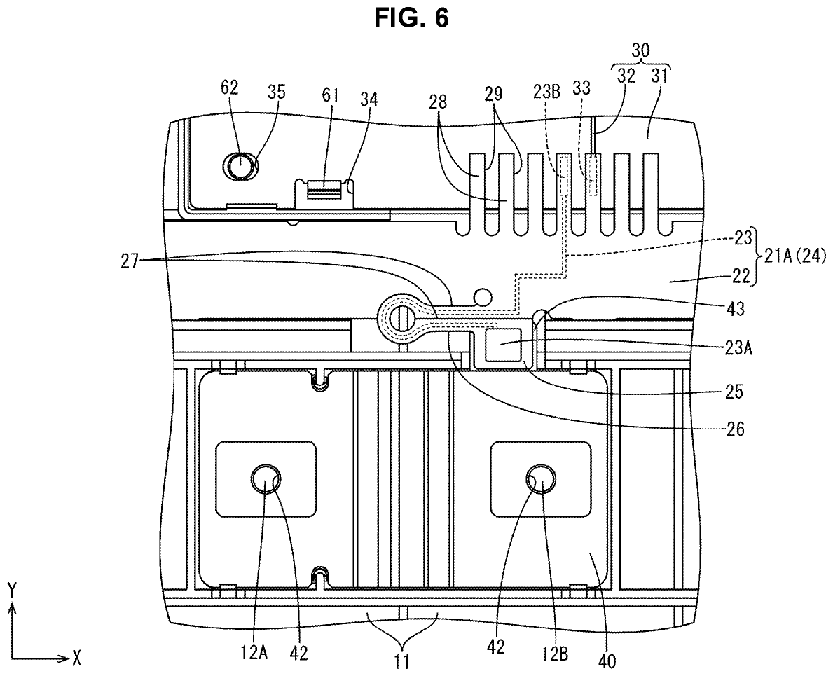

The flexible substrate 21A is a sheet-like substrate that has flexibility. As shown in FIG. 6, the flexible substrate 21A has a base film 22 that is made of an insulating synthetic resin and first conductive paths 23 (partially shown in FIG. 6) routed on the base film 22. Although not shown, the base film 22 and the first conductive path 23 are covered with an insulating overlay film and an insulating layer of a coating film. The material for the base film 22 and the insulating layer may be polyimide (PI), polyethylene terephthalate (PET), or the like. Each first conductive path 23 is made of a metal such as copper or a copper alloy, and possesses electrical conductivity. In the present embodiment, the first conductive paths 23 are routed on one surface of the flexible substrate 21A, and the flexible substrate 21A is disposed such that the surface on which the first conductive paths 23 are routed faces down.

### [Wiring Part]

As shown in FIG. 5, the flexible substrates 21A and 21B are disposed between the circuit substrate 30 and the busbars 40 in the left-right direction (the up-down direction in FIG. 5). As shown in FIG. 6, the flexible substrate 21A includes a wiring part 24 that extends in a band shape in the front-back direction (the left-right direction in FIG. 5), first connection pieces 25 that are provided on the side facing the busbars 40, bridge parts 26 that couple the wiring part 24 and the first connection pieces 25, and second connection pieces 28 that extend from the wiring part 24 toward the circuit substrate 30.

### [First Connection Pieces]

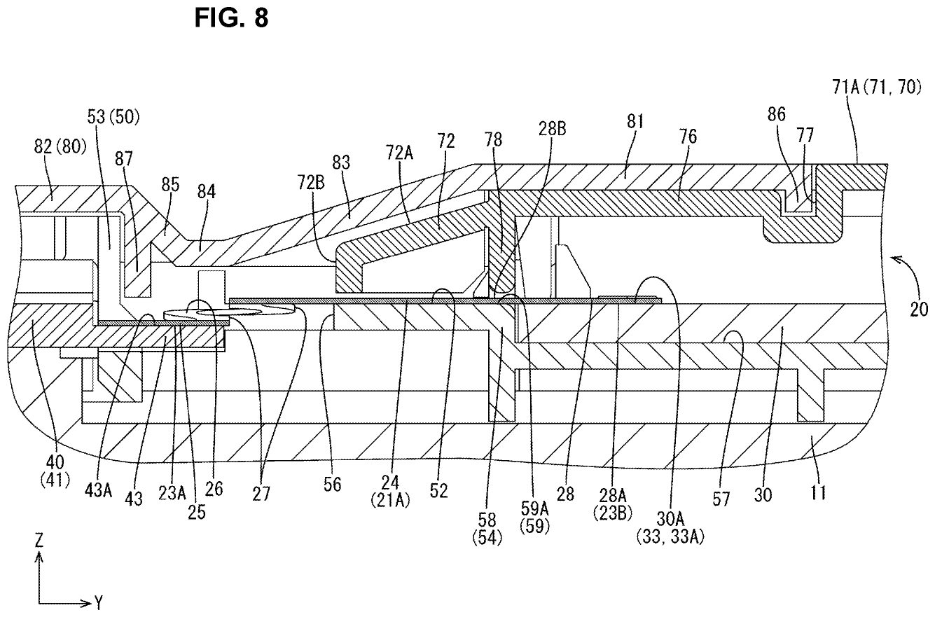

As shown in FIG. 8, the first connection piece 25 is overlaid on an upper surface 43A of a busbar-side connection part 43 of the busbar 40. As shown in FIG. 6, a first land 23A disposed at an end portion of the first conductive path 23 is provided on the lower surface of the first connection piece 25. No insulating layer is provided on the lower side of the first land 23A, and the first land 23A is exposed downward. The first land 23A is electrically connected to the corresponding busbar-side connection part 43 through soldering.

### [Bridge Parts]

As shown in FIG. 6, each bridge part 26 has cutout parts 27 that are cut in the front-back direction and have an elongated shape. Due to the cutout parts 27, the bridge part 26 can extend in the front-back direction, the up-down direction, and the left-right direction. As shown in FIG. 8, the bridge part 26 of the present embodiment mainly extends in the up-down direction to couple the wiring part 24 and the first connection piece 25. Using the bridge parts 26, it is also possible to absorb manufacturing tolerances in the busbars 40, the flexible substrate 21A, and the protector 50, and assembly tolerances of these components.

### [Second Connection Pieces]

As shown in FIG. 6, the second connection pieces 28 each have a rectangular strip shape and are arranged in the front-back direction. Adjacent second connection pieces 28 are divided by slits 29. As shown in FIG. 8, the second connection pieces 28 are overlaid on an upper surface 30A of the circuit substrate 30. A second land 23B is formed on a lower surface 28A of each second connection piece 28. As shown in FIG. 6, the second land 23B is disposed at an end portion of the first conductive path 23 on a side opposite to the first land 23A. No insulating layer is provided on the lower sides of the second lands 23B. Similarly to the first lands 23A the second lands 23B are exposed downward. The second lands 23B are electrically connected to circuit substrate-side connection parts 33 of the circuit substrate 30 through soldering (see FIG. 6).

### [Circuit Substrate]

The circuit substrate 30 according to the present embodiment is a non-flexible rigid substrate. As shown in FIG. 6, the circuit substrate 30 includes an insulating plate 31 that has insulating properties, and a second conductive path 32 (partially shown in the drawing) that is routed on the insulating plate 31. The insulating plate 31 is formed by impregnating a glass fiber cloth with an epoxy resin and then curing the epoxy resin, for example. The second conductive path 32 is made of a metal such as copper or a copper alloy, for example, and possesses electrical conductivity. The circuit substrate 30 is disposed such that the surface on which the second conductive path 32 of the insulating plate 31 is routed faces up.

As shown in FIG. 5, the circuit substrate 30 has a rectangular shape that is elongated in the front-back direction. The circuit substrate 30 has an electronic component E and a connector C mounted thereon. Examples of the electronic component E include a resistor, a capacitor, a switching element, or the like. The circuit substrate 30 is electrically connected to an un-shown external electronic control unit (ECU) by the connector C. The ECU has a microcomputer, an element, and the like mounted thereon, and is provided in a known configuration for performing functions to detect the voltage, current, temperature, and the like of the power storage elements 11 and to control the charging and discharging of the power storage elements 11. The circuit substrate 30 of the present embodiment can be provided with a function to monitor information regarding the voltage and temperature of the power storage elements 11 and transmit the information to the ECU. As shown in FIGS. 6 and 7, the circuit substrate 30 includes locking recessed parts 34 that have a concave shape, and a through hole 35 that extends through the circuit substrate 30 in the up-down direction.

### [Circuit Substrate-Side Connection Parts]

As shown in FIG. 6, a circuit substrate-side connection part 33 is provided at an end portion of the second conductive path 32. The second connection pieces 28 are respectively overlaid on upper surfaces 33A of the circuit substrate-side connection parts 33. The circuit substrate-side connection parts 33 are connected to the second lands 23B provided on the second connection pieces 28 through soldering.

As shown in FIG. 8, in the present embodiment, the lower surfaces 28A of the second connection piece 28 and the upper surfaces 33A of the circuit substrate-side connection part 33 are designed to be flush with each other. The lower surfaces 28A of the second connection pieces 28 include the second lands 23B. Either the second lands 23B or the circuit substrate-side connection parts 33 are provided with solder (not shown) in advance, and the second lands 23B and the circuit substrate-side connection parts 33 are soldered to each other using a reflow method. Since the lower surfaces 28A of the second connection pieces 28 and the upper surfaces 33A of the circuit substrate-side connection parts 33 are made flush with each other, no excessive force is applied to the solder connecting the second connection pieces 28 and the circuit substrate-side connection parts 33. This makes it possible to improve the reliability of electrical connection between the flexible substrate 21A and the circuit substrate 30.

### [Busbars]

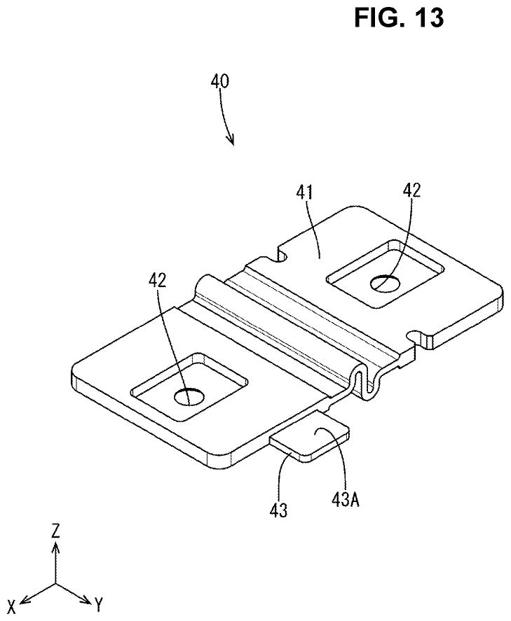

As shown in FIG. 6, the busbars 40 are members for connecting the electrode terminals 12A and 12B of adjacent power storage elements 11, and are formed by a metallic plate member with electrical conductivity. Examples of the metal constituting the busbars 40 include copper, a copper alloy, aluminum, an aluminum alloy, stainless steel (SUS), and the like. As shown in FIG. 13, each busbar 40 has a busbar main body part 41 that has a rectangular shape, two electrode insertion holes 42 that extend through the busbar main body part 41 in the up-down direction, and the busbar-side connection part 43 that protrudes outward (rightward or leftward) from the busbar main body part 41. As shown in FIG. 6, the electrode terminals 12A and 12B are inserted into the electrode insertion holes 42. The busbar 40 and the electrode terminals 12A and 12B are electrically connected to each other through welding.

### [Busbar-Side Connection Part]

As shown in FIG. 13, the busbar-side connection part 43 has the upper surface 43A provided at a position lower than the upper surface of the busbar main body part 41. As shown in FIG. 8, in the wiring module 20, the upper surface 43A of the busbar-side connection part 43 is set so as to be lower than a wiring surface 52 of the protector 50 and the upper surface 30A of the circuit substrate 30. The upper surface 43A of the busbar-side connection part 43 is connected to the first land 23A provided on the lower surface of the first connection piece 25 through soldering.

### [Protector]

The protector 50 is made of an insulating synthetic resin and has a plate-like shape. As shown in FIG. 5, the protector 50 includes a protector main body part 51 at the center thereof in the left-right direction, the wiring surfaces 52 that are provided on both left and right sides of the protector main body part 51 and on which the wiring parts 24 of the flexible substrates 21A and 21B are provided, and busbar installation parts 53 that are provided at the left end portion and right end portion of the protector 50 and in which the busbars 40 are disposed. An attachment part 54 to which the circuit substrate 30 is attached is provided in the front half portion of the protector main body part 51.

### [Wiring Surfaces]

As shown in FIG. 5, the wiring surfaces 52 extend in the front-back direction. A division wall 55 is provided on both the left and right sides of each wiring surface 52. The wiring parts 24 of the flexible substrates 21A and 21B are respectively fixed onto the wiring surfaces 52 using an adhesive, duct tape, thermal caulking, or the like, and are divided by the division walls 55. As shown in FIG. 7, the division wall 55 between the flexible substrate 21A and the circuit substrate 30 also serves as a division wall 58 constituting the attachment part 54.

### [Openings]

As shown in FIG. 7, the protector 50 has openings 56 that extend through the protector 50 in the up-down direction between the wiring surface 52 and the busbar installation parts 53 (the opening edges are partially shown by broken lines). When viewed from above, each opening 56 includes a bridge part 26 therein. In a cross-section view as seen from the front, the bridge part 26 is disposed above or inside the opening 56, as shown in FIG. 8. Since the bridge parts 26 have an elongated shape including the cutout parts 27, the water dew adhering to the bridge parts 26 is likely to be drained downward (that is, toward the power storage elements 11) through the openings 56.

As shown in FIG. 8, since the wiring surfaces 52 are disposed above the upper surfaces 43A of the busbar-side connection parts 43, the wiring parts 24 are disposed above the first connection pieces 25. Accordingly, the water dew is unlikely to enter from the busbars 40 into the wiring parts 24 via the bridge parts 26 coupling the wiring parts 24 and the first connection pieces 25. Each bridge part 26 in the present embodiment has the cutout parts 27, and thus the bridge part 26 can extend by an amount corresponding to a vertical shift between the wiring part 24 and the first connection piece 25 and therefore couple the wiring part 24 and the first connection piece 25 to each other. Therefore, the bridge part 26 does not need an excess length corresponding to the vertical shift between the wiring part 24 and the first connection piece 25. This reduces the usage of the flexible substrates 21A and 21B.

### [Attachment Parts]

As shown in FIG. 7, the attachment part 54 includes the division walls 58 that surround the outer edge part of the circuit substrate 30, and recessed parts 59 that are provided in the division walls 58 on the right and left sides of the circuit substrate 30. As shown in FIG. 8, each recessed part 59 in the present embodiment has an internal upper end 59A that smoothly continues toward the wiring surface 52 without a step. The second connection pieces 28 extending from the wiring part 24 toward the circuit substrate 30 are correspondingly inserted into the recessed parts 59. The surface of the attachment part 54 that abuts against the lower surface of the circuit substrate 30 constitutes a bottom surface 57. As shown in FIG. 5, a first connector recessed part 60 to which the connector C is attached is provided at the front end portion of the attachment part 54.

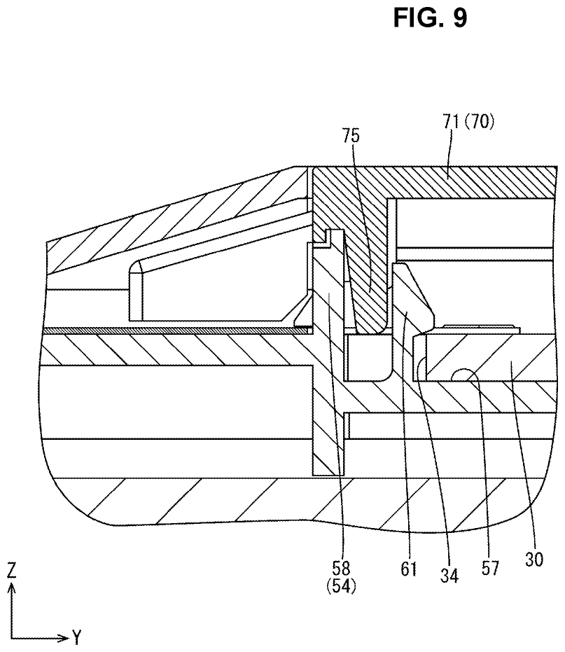

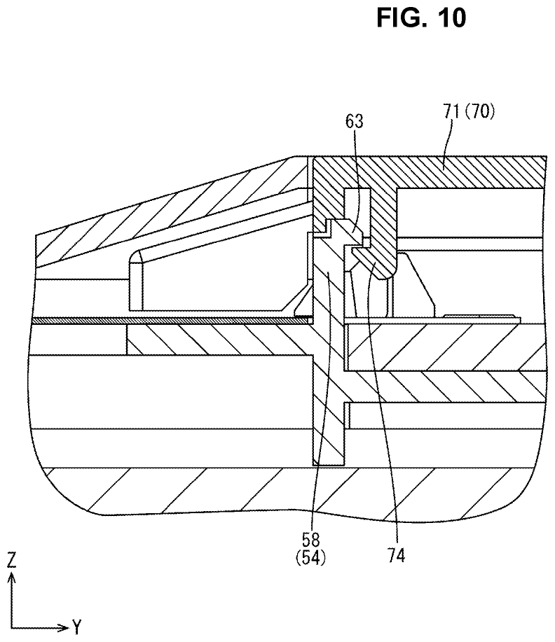

As shown in FIG. 9, the bottom surface 57 is provided with locking pieces 61 that extend upward and are flexibly deformable in the left-right direction. The locking pieces 61 are disposed so as to engage with the corresponding locking recessed part 34 of the circuit substrate 30. As shown in FIG. 7, the attachment part 54 is provided with a columnar positioning protruding part 62 that extends upward. The positioning protruding part 62 is inserted into the through hole 35 of the circuit substrate 30 to position the circuit substrate 30 on the attachment part 54. As shown in FIG. 10, the division wall 58 is provided with a locking projection 63 that protrudes inward of the attachment part 54.

As shown in FIG. 7, the busbar installation parts 53 each have a frame shape and are formed such that the busbars 40 can be disposed therein in the front-back direction. Each busbar installation part 53 includes locking claws 64 that hold the busbar 40. Each busbar installation part 53 has a busbar recessed part 65 that houses the busbar-side connection part 43. The busbar-side connection part 43 housed in the busbar recessed part 65 protrudes outward of the busbar installation part 53 and is disposed in the opening 56. As shown in FIG. 8, each busbar installation part 53 is partially bottomless, and the busbar 40 held by the busbar installation part 53 is electrically connected to a plurality of power storage elements 11.

### [Cover and Overhang Parts]

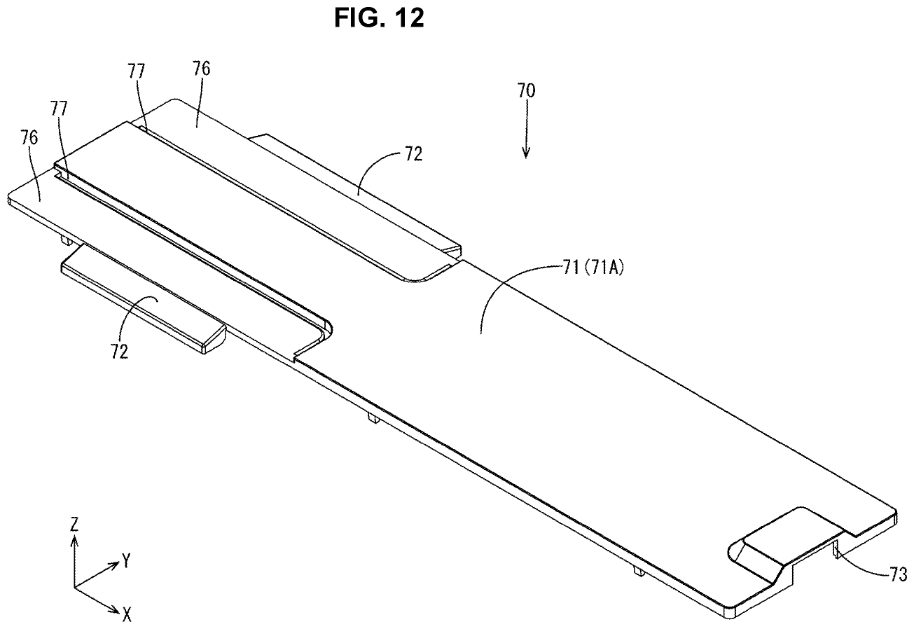

The cover 70 is made of an insulating synthetic resin and is a lid-like member. As shown in FIG. 12, the cover 70 has a cover main body part 71 that has a square shape when viewed from above and overhang parts 72 that protrude in the left-right direction from the cover main body part 71. As shown in FIG. 8, the cover 70 is attached to the attachment part 54 and is configured to cover the circuit substrate 30 from above. The overhang parts 72 protrude toward the outside of the attachment part 54.

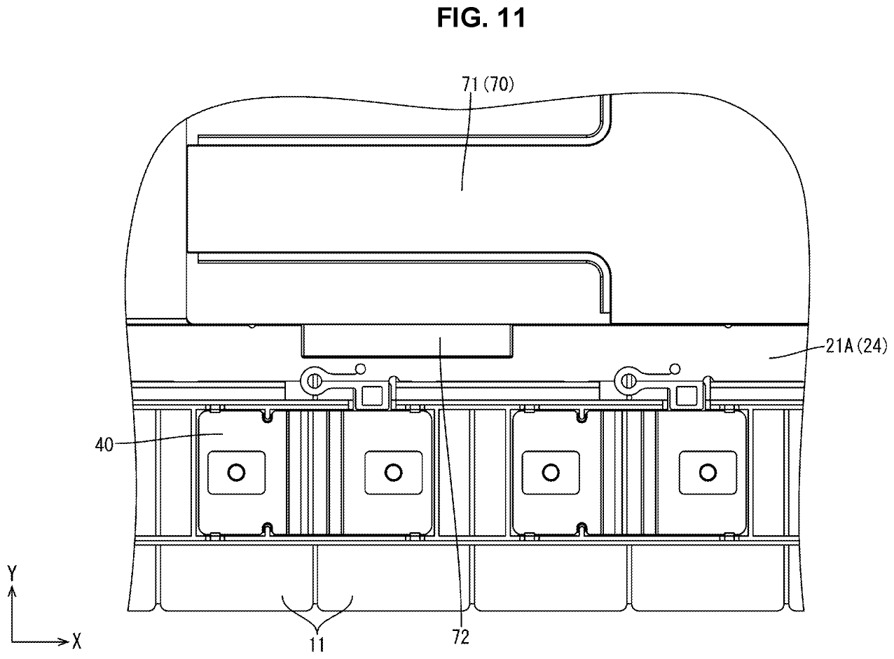

As can be seen from a comparison between FIG. 7 and FIG. 11, the overhang parts 72 are configured to cover the recessed parts 59 and the second connection pieces 28 from above. Accordingly, even if water dew adhering to the ceiling surface of the casing falls onto the cover 70, it is possible to keep water dew from entering the circuit substrate 30.

As shown in FIG. 8, the upper surface 72A of the overhang part 72 is inclined so as to decrease in height while extending outward (toward the left side of FIG. 8) from the cover main body part 71. This makes it possible to drain water dew falling from the cover 70 toward the wiring parts 24, the wiring surfaces 52, and the like below. In addition, edges 72B of the overhang parts 72 are partially disposed above the opening edge portions of the openings 56, and thus the water dew on the upper surfaces 72A of the overhang parts 72 can also be drained toward the power storage elements 11 through the openings 56.

As shown in FIG. 8, the cover 70 has cover-side partition walls 78 that extend downward and are respectively disposed in the recessed parts 59. The lower end portions of the cover-side partition walls 78 are disposed so as not to come into contact with the upper surfaces 28B of the second connection pieces 28. The cover-side partition walls 78 are connected to the division walls 58 of the attachment part 54 in the front-back direction (the up-down direction on the plane of the drawing). That is, the cover-side partition walls 78 are configured to partially close the recessed parts 59 in the left-right direction, and thus can suppress the entry of water dew into the attachment part 54.

As shown in FIG. 12, a second connector recessed part 73 is provided at the front end portion of the cover main body part 71. As shown in FIG. 2, the second connector recessed part 73 is attached to the top of the connector C that is attached to the first connector recessed part 60. Accordingly, the connector C is surrounded by the first connector recessed part 60 and the second connector recessed part 73 without a gap.

As shown in FIG. 10, a locking part 74 that engages with the locking projection 63 is provided on the lower side of the cover main body part 71. This allows the cover 70 to be locked to the attachment part 54. As shown in FIG. 9, engagement projections 75 are disposed on the lower side of the cover main body part 71 between the division wall 58 and the locking pieces 61. The engagement projections 75 position the cover 70 with respect to the attachment part 54, and the locking pieces 61 warp toward the division wall 58 to suppress unlocking of the locking pieces 61 and the locking recessed parts 34 of the circuit substrate 30 from each other.

As shown in FIG. 12, step parts 76 recessed downward relative to the upper surface 71A of the cover main body part 71 are provided at a left portion and a right portion on the back half part of the cover main body part 71. The step parts 76 extend forward and backward relative to the overhang parts 72. The step parts 76 are connected to the upper surface 71A of the cover main body part 71 by groove parts 77. As shown in FIG. 8, the groove parts 77 are recessed downward relative to the step parts 76.

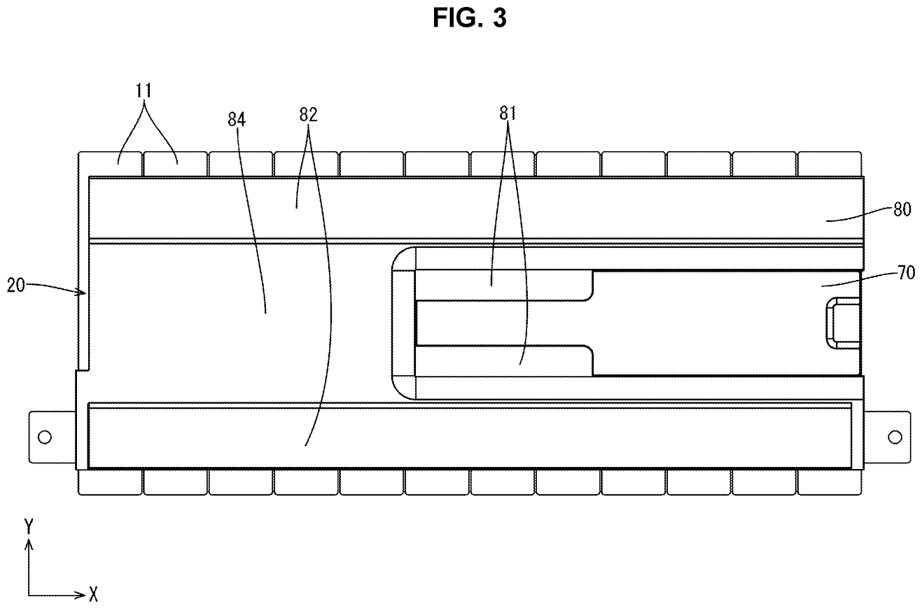

The outer cover 80 is made of an insulating synthetic resin and is a lid-like member similarly to the cover 70. As shown in FIGS. 2 and 3, the outer cover 80 is a member for covering a portion of the cover 70 and an outer portion of the wiring module 20 not covered by the cover 70 from above. That is, as shown in FIG. 8, the outer cover 80 covers the wiring parts 24 outside of the attachment part 54, the busbars 40, and the like from above. Although not described in detail, the outer cover 80 (an outer wall part 82) and the outer edge portion (the busbar installation parts 53) of the protector 50 each include a locking structure similar to the locking part 74 and the locking projection 63 shown in FIG. 10 with which the outer cover 80 can be attached to the protector 50.

As shown in FIG. 8, the outer cover 80 has an inner wall part 81 that is overlaid on the upper surfaces of the step parts 76 of the cover 70 and an outer wall part 82 that covers the busbars 40 and the busbar installation parts 53 from above. A first inclined part 83, an intermediate wall part 84, and a second inclined part 85 are provided between the inner wall part 81 and the outer wall part 82. The intermediate wall part 84 is provided at a position lower than the inner wall part 81 and the outer wall part 82. The intermediate wall part 84 is connected to the inner wall part 81 via the first inclined part 83, and is connected to the outer wall part 82 via the second inclined part 85.

As shown in FIG. 8, engagement protruding parts 86 protruding downward are provided at an inner end portion of the inner wall part 81. The engagement protruding parts 86 engage with the groove parts 77 of the cover 70 to position the outer cover 80 relative to the cover 70. The engagement protruding parts 86 and the groove parts 77 engage with each other with a clearance therebetween so that, once a certain amount of water dew has accumulated in the groove parts 77, the water dew enters the outer cover 80. In this manner, since the recessed parts 59 of the protector 50 and their surrounding regions are doubly covered by the outer cover 80 and the cover 70 from above, water dew falling from above is unlikely to enter the circuit substrate 30.

As shown in FIG. 8, a protruding wall 87 extending downward is provided on the outer wall part 82 side of the second inclined part 85. The protruding wall 87 is provided close to the busbar installation parts 53 so that water dew adhering to the busbars 40 and the busbar installation parts 53 is guided downward by the protruding wall 87 and is drained downward through the openings 56. The first inclined part 83 is formed so that there is a clearance between the first inclined part 83 and the upper surfaces 72A of the overhang parts 72. Accordingly, even if water dew enters a space between the outer cover 80 and the cover 70, the water dew is likely to be drained by the overhang parts 72.

As shown in FIG. 8, water dew flows along the first inclined part 83 and the second inclined part 85 and is collected on the intermediate wall part 84, which is lower than the surrounding wall parts. The water dew adhering to the inside of the outer cover 80 is collected on the lower surface of the intermediate wall part 84 and is likely to be drained to the openings 56 and the wiring parts 24 under the intermediate wall part 84. On the outside of the outer cover 80, the water dew is likely to accumulate on the upper surface of the intermediate wall part 84, and is unlikely to accumulate on the upper surface of the inner wall part 81. Accordingly, the water dew falling from above is unlikely to enter the circuit substrate 30 through the groove parts 77. As shown in FIGS. 2 and 3, the upper surface of the intermediate wall part 84 has a region into which the adhering water dew escapes (for example, the back half part of the outer cover 80), and thus the formation on water dew here causes no problems.

### [Operations and Advantageous Effects of First Embodiment]

According to the first embodiment, it is possible to exhibit the following operation and effects. The wiring module 20 according to the first embodiment is the wiring module 20 that is mounted on the plurality of power storage elements 11. The wiring module 20 includes the busbars 40 that are connected to the electrode terminals 12A and 12B of the plurality of power storage elements 11, the flexible substrates 21A and 21B that are connected to the busbar-side connection parts 43 provided on the busbars 40, the circuit substrate 30 that is connected to the flexible substrates 21A and 21B, and the protector 50 on which the busbars 40, the flexible substrates 21A and 21B, and the circuit substrate 30 are placed. The upper surface 30A of the circuit substrate 30 is disposed above the upper surfaces 43A of the busbar-side connection parts 43.

According to the foregoing configuration, since the circuit substrate 30 is connected to the busbar-side connection parts 43 via the flexible substrates 21A and 21B, and the upper surface 30A of the circuit substrate 30 is disposed above the upper surfaces 43A of the busbar-side connection parts 43, it is possible to suppress the entry of water dew from the busbars 40 into the circuit substrate 30.

In the first embodiment 1, the flexible substrates 21A and 21B each include the wiring part 24, the first connection pieces 25 that are overlaid on and connected to the upper surfaces 43A of the busbar-side connection parts 43, and the bridge parts 26 that couple the wiring parts 24 and the first connection pieces 25. The protector 50 has the wiring surfaces 52 on which the wiring parts 24 are placed, the busbar installation parts 53 in which the busbars 40 are disposed, and the openings 56 that are provided between the wiring surfaces 52 and the busbar installation parts 53 and vertically extend through the protector 50. At least a portion of each bridge part 26 is disposed above or inside the corresponding opening 56.

According to the above-described configuration, the water dew having accumulated in the bridge parts 26 is likely to be drained downward through the openings 56. Accordingly, it is possible to suppress the entry of water dew from the busbars 40 into the wiring parts 24 of the flexible substrates 21A and 21B through the bridge parts 26.

In the first embodiment, the wiring surfaces 52 are disposed above the upper surfaces 43A of the busbar-side connection parts 43.

According to the above-described configuration, since the wiring parts 24 of the flexible substrates 21A and 21B are disposed above the first connection pieces 25, it is possible to suppress the entry of the water dew from the busbars 40 into the wiring parts 24 through the bridge parts 26.

In the first embodiment, the bridge parts 26 have the cutout parts 27 and are provided in an extendable manner.

According to the above-described configuration, the provision of the cutout parts 27 makes the water dew more likely to be drained downward from the bridge parts 26 through the openings 56. Even if the wiring surfaces 52 and the upper surfaces 43A of the busbar-side connection parts 43 are positionally shifted from each other in the up-down direction, the bridge part is vertically extendable and thus the bridge part 26 does not need an extra length.

In the first embodiment, the protector 50 has the attachment part 54 to which the circuit substrate 30 is attached. The attachment part 54 has the partition walls 58 that surround the outer edge part of the circuit substrate 30 and the recessed parts 59 that are provided in the partition walls 58. The flexible substrates 21A and 21B each include the second connection pieces 28 that extend from the wiring parts 24 through the recessed parts 59 toward the circuit substrate 30. The second connection pieces 28 are overlaid on and connected to the upper surface 30A of the circuit substrate 30.

According to the above-described configuration, the circuit substrate 30 is surrounded by the partition walls 58 except for the recessed parts 59 necessary for connecting the flexible substrates 21A and 21B and the circuit substrate 30. This makes it possible to suppress the entry of water dew from outside of the attachment part 54 into the circuit substrate 30.

In the first embodiment, the cover 70 is attached to the attachment part 54 to cover the circuit substrate 30 from above.

According to the above-described configuration, it is possible to suppress the entry of water dew falling from above into the circuit substrate 30.

In the first embodiment, the cover 70 has the cover main body part 71 that is disposed above the attachment part 54 and the overhang parts 72 that protrude from the cover main body part 71 toward outside of the attachment part 54. The overhang parts 72 cover the second connection pieces 28 from above. The upper surfaces 72A of the overhang parts 72 are inclined so as to decrease in height while extending outward from the cover main body part 71.

According to the above-described configuration, it is possible to suppress adhesion of water dew that has fallen from above to the second connection pieces 28. It is also possible to drain the water dew falling from above downward through the overhang parts 72.

In the first embodiment, the circuit substrate 30 includes the circuit substrate-side connection parts 33 that are connected to the second connection pieces 28. The lower surfaces 28A of the second connection pieces 28 and the upper surfaces 33A of the circuit substrate-side connection parts 33 are flush with each other.

According to the above-described configuration, it is possible to improve the reliability of connection between the flexible substrates 21A and 21B and the circuit substrate 30.

### Second Embodiment

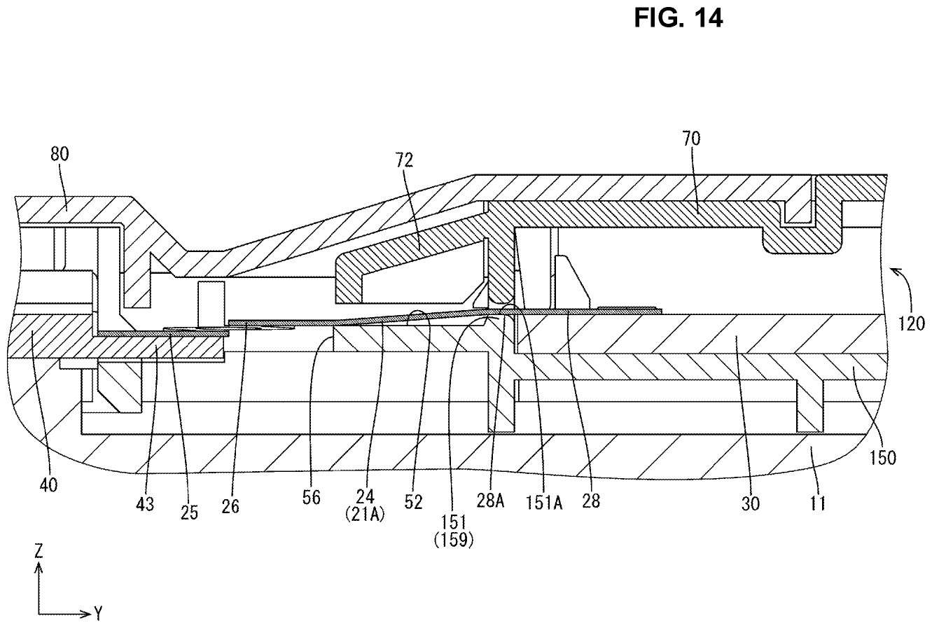

A second embodiment of the present disclosure will be described with reference to FIG. 14. A wiring module 120 according to the second embodiment is configured in the same manner as the first embodiment except that a protector 150 has a water blocking wall 151. Thus, description of the members and operations and advantageous effects of the second embodiment identical to those of the first embodiment will be omitted. For a plurality of identical members, only some of the members may be denoted with reference signs and the reference signs for the other members may be omitted.

As shown in FIG. 14, the water blocking walls 151 extending upward past the wiring surfaces 52 are provided inside recessed parts 159 in the protector 150. Thus, the water blocking walls 151 make water dew unlikely to enter from the wiring surfaces 52 into the circuit substrate 30. The water blocking walls 151 have upper end portions 151A that are in contact with the lower surfaces 28A of second connection pieces 28 that are passed though the recessed parts 159. Therefore, wiring parts 24 are inclined downward from the circuit substrate 30 side toward the openings 56, which makes it possible to suppress the entry of water dew from the wiring parts 24 into the circuit substrate 30.

### [Operations and Advantageous Effects of Second Embodiment]

According to the second embodiment, it is possible to produce the following operations and advantageous effects. In the second embodiment, the recessed parts 159 are provided with the water blocking walls 151 that extend upward from the wiring surfaces 52 and are in contact with the lower surfaces 28A of the second connection pieces 28.

According to the above-described configuration, the water blocking walls 151 make it possible to suppress the intrusion of water dew from the wiring surfaces 52 and the wiring parts 24 into the circuit substrate 30.

### Third Embodiment

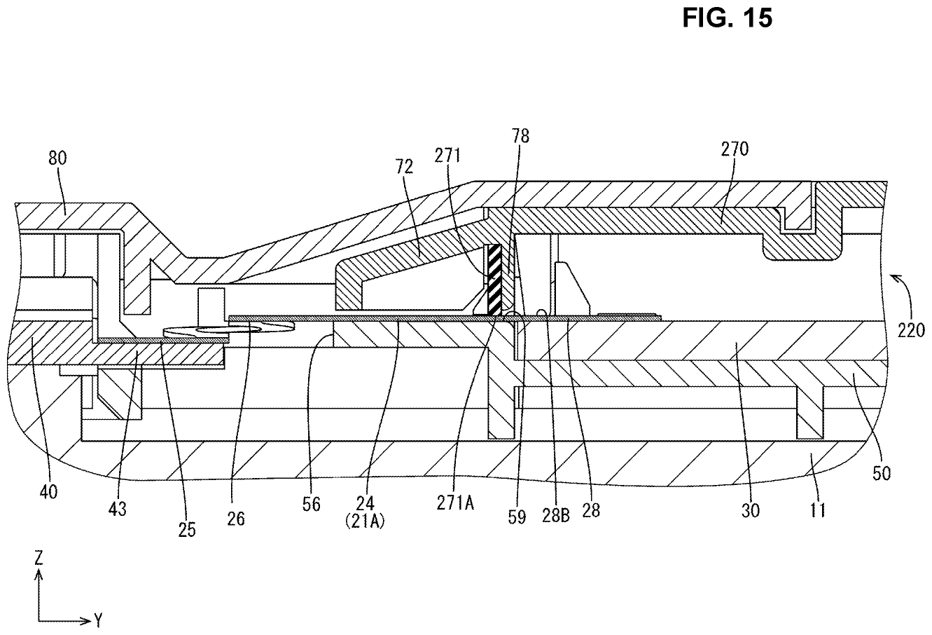

A third embodiment of the present disclosure will be described with reference to FIG. 15. A wiring module 220 according to the third embodiment is configured in the same manner as the first embodiment except that a cover 270 has closure parts 271. Thus, description of the members and operations and advantageous effects of the third embodiment identical to those of the first embodiment will be omitted. For a plurality of identical members, only some of the members may be denoted with reference signs and the reference signs for the other members may omitted.

As shown in FIG. 15, the closure parts 271 made of an elastic material such as sponge or rubber are attached to cover-side partition walls 78 of the cover 270. Since the closure parts 271 are made of an elastic material, the closure parts 271 can be provided such that lower end portions 271A come into contact with the upper surfaces 28B of second connection pieces 28. Accordingly, the closure parts 271 cover the entirety of the recessed parts 59 in the left-right direction, which makes it possible to suppress the entry of water dew from the wiring parts 24 into the circuit substrate 30. If the closure parts 271 are made of a sponge, it is possible to suppress the entry of water dew into the circuit substrate 30 as a result of the sponge absorbing the water dew.

### [Operation and Advantageous Effects of Third Embodiment]

According to the third embodiment, it is possible to exhibit the following operation and advantageous effects. In the third embodiment, the cover 270 includes the closure parts 271 that are disposed to close the recessed parts 59 and are made of an elastic material. The lower end portions 271A of the closure parts 271 are in contact with the upper surfaces 28B of the second connection pieces 28.

According to the above-described configuration, the closure parts 271 make it possible to suppress the entry of water from the wiring parts 24 into the circuit substrate 30.

### OTHER EMBODIMENTS

(1) In the above-described embodiments, the circuit substrate 30 is a rigid substrate. However, the present disclosure is not limited to this, and the circuit substrate may be a flexible substrate.

(2) In the above-described embodiments, the busbars 40 and the flexible substrates 21A and 21B are directly connected to each other. However, the present disclosure is not limited to this, and the busbars and the flexible substrates may be connected via small pieces of metal such as nickel.

(3) In the above-described embodiments, the outer cover 80 is provided outside of the cover 70. However, the present disclosure is not limited to this, and an outer cover may not necessarily be provided.

### LIST OF REFERENCE NUMERALS

1 Vehicle
2 Power storage pack
3 PCU
4 Wire harness
10 Power storage module
11 Power storage element
12A, 12B Electrode terminal
20, 120, 220 Wiring module
21A, 21B Flexible substrate
22 Base film
23 First conductive path
23A First land
23B Second land
24 Wiring part
25 First connection piece
26 Bridge part
27 Cutout part
28 Second connection piece
28A Lower surface of second connection piece
28B Upper surface of second connection piece
29 Slit
30 Circuit substrate
30A Upper surface of circuit substrate
31 Insulating plate
32 Second conductive path
33 Circuit substrate-side connection part
33A Upper surface of circuit substrate-side connection part
34 Locking recessed part
35 Through hole
40 Busbar
41 Busbar main body part
42 Electrode insertion hole
43 Busbar-side connection part
43A Upper surface of busbar-side connection part
50, 150 Protector
51 Protector main body part
52 Wiring surface
53 Busbar installation part
54 Attachment part
55 Division wall
56 Opening
57 Bottom surface
58 Partition wall
59, 159 Recessed part
59A Internal upper end of recessed part
60 First connector recessed part
61 Locking piece
62 Positioning protruding part
63 Locking projection
64 Locking claw
65 Busbar recessed part
70, 270 Cover
71 Cover main body part
71A Upper surface of cover main body part
72 Overhang part
72A Upper surface of overhang part
72B Edge of overhang part
73 Second connector recessed part
74 Locking part
75 Engagement projection
76 Step part
77 Groove part
78 Cover-side partition wall
80 Outer cover
81 Inner wall part
82 Outer wall part
83 First inclined part
84 Intermediate wall part
85 Second inclined part
86 Engagement protruding part
87 Protruding wall
151 Water blocking wall
151A Upper end portion of water blocking wall
271 Closure part
271A Lower end portion of closure part
C Connector
E Electronic component

1. A wiring module that is mounted on an upper side of a plurality of power storage elements, comprising:
a busbar that is connected to electrode terminals of the plurality of power storage elements;
a flexible substrate that is connected to a busbar-side connection part provided on the busbar;
a circuit substrate that is connected to the flexible substrate; and
a protector on which the busbar, the flexible substrate, and the circuit substrate are placed,
wherein an upper surface of the circuit substrate is disposed above an upper surface of the busbar-side connection part.

2. The wiring module according to claim 1,
wherein the flexible substrate includes a wiring part, a first connection piece that is overlaid on and connected to the upper surface of the busbar-side connection part, and a bridge part that couples the wiring part and the first connection piece,
the protector has a wiring surface on which the wiring part is placed, a busbar installation part in which the busbar is disposed, and an opening that is provided between the wiring surface and the busbar installation part and extends through the protector in an up-down direction, and
at least a portion of the bridge part is disposed above or inside the opening.

3. The wiring module according to claim 2,
wherein the wiring surface is disposed above the upper surface of the busbar-side connection part.

4. The wiring module according to claim 3,
wherein the bridge part has a cutout part and is provided in an extendable manner.

5. The wiring module according to claim 2,
wherein the protector has an attachment part to which the circuit substrate is attached,
the attachment part has a partition wall that surrounds an outer edge part of the circuit substrate and a recessed part that is provided in the partition wall,
the flexible substrate includes a second connection piece that extends from the wiring part and toward the circuit substrate through the recessed part, and
the second connection piece is overlaid on and connected to an upper surface of the circuit substrate.

6. The wiring module according to claim 5,
wherein the recessed part is provided with a water blocking wall that extends upward from the wiring surface and is in contact with a lower surface of the second connection piece.

7. The wiring module according to claim 5,
wherein a cover is attached to the attachment part to cover the circuit substrate from above.

8. The wiring module according to claim 7,
wherein the cover is provided with a closure part that is disposed to close the recessed part and is made of an elastic material, and
a lower end portion of the closure part is in contact with an upper surface of the second connection piece.

9. The wiring module according to claim 7,
wherein the cover has a cover main body part that is disposed above the attachment part and an overhang part that protrudes from the cover main body part toward the outside of the attachment part,
the overhang part covers the second connection piece from above, and
the upper surface of the overhang part is inclined so as to decrease in height while extending outward from the cover main body part.

10. The wiring module according to claim 5,
wherein the circuit substrate includes a circuit substrate-side connection part that is connected to the second connection piece, and
the lower surface of the second connection piece and an upper surface of the circuit substrate-side connection part are flush with each other.

11. The wiring module according to claim 1,
wherein the wiring module is a vehicle wiring module that is used mounted in a vehicle.
